(19) United States
(12) Patent Application Publication
(10) Pub. No.: US 2005/0001065 A1
(43) Pub. Date: Jan. 6, 2005

(54) Nozzle apparatus and method for atomizing fluids

(75) Inventor: Joseph A. Senecal, Wellesley, MA (US)

Correspondence Address: MERCHANT & GOULD PC, P.O. BOX 2903, MINNEAPOLIS, MN, 55402-0903, US

(73) Assignee: KIDDE-FENWAL, INC., ASHLAND, MA (US)

(21) Appl. No.: 10/865,175

(22) Filed: Jun. 9, 2004

Related U.S. Application Data
(63) Continuation-in-part of application No. 09/920,360, filed on Aug. 1, 2001, now Pat. No. 6,763,894.

(51) Int. Cl. A62C 3/07; A62C 3/08; A62C 35/00

(52) U.S. Cl. 239/461; 239/463; 239/498

(57) ABSTRACT

An atomizing nozzle for a fire suppression system, having a nozzle body and a deflector body secured together. A flow passage defined between the deflector body and nozzle body extends radially outwardly from an inlet port to a circumferential outlet slot, the outlet slot being defined between the nozzle body and deflector body and extending at least partially around the. Vanes are disposed in the flow passage, and are arranged so as to impart to fluid flowing through said flow passage a tangential velocity component relative to the axis of the flow passage. The vanes may be arranged such that the tangential velocity component is sufficient to impart to gas in the area a rotational motion about the axis. The vanes may be removable, and may be retrofitted to existing nozzles. The nozzles also may be removable, and may be retrofitted to existing fire suppression systems.

### CROSS REFERENCE TO RELATED APPLICATIONS

The present application is a continuation in part of U.S. patent application Ser. No. 09/920,360, filed Aug. 1, 2001, entitled CLEAN AGENT FIRE SUPPRESSION SYSTEM AND RAPED ATOMIZING NOZZLE FOR SAME, which is in its entirety incorporated herewith by reference.

### FIELD OF THE INVENTION

This invention relates to an apparatus and method for atomizing fluids, such as fire suppressing fluids. The invention relates more particularly to an apparatus and a method for efficiently distributing an atomized fluid via a nozzle throughout a volume filled with air or other gas, in such a way as to impart a transverse velocity component as well as a radial component to the fluid.

### BACKGROUND OF THE INVENTION

There are a wide variety of fire suppression systems commercially available today. One form of fire suppression system is known as a fixed “clean agent” gaseous fire suppression system. Clean agent fire extinguishing systems extinguish fires by creating a fire extinguishing atmosphere consisting of agent vapor or gas mixed with the air within the protected space. Clean agent systems are used in buildings and other such structures to suppress fires without water, powder or foam so not as to destroy or damage an area of the structure and/or equipment contained therein. Clean agent fire suppressants leave no residue upon evaporation. One common form of clean agent is a chemical that is in liquefied form under normal storage conditions but which may be vaporized to form a gaseous mixture with air which does not support combustion and extinguishes fires. Such liquefied-gas suppressants exist in liquid form when confined in a closed container, but exist as a gas at ambient temperature and when not confined in a container.

Clean agent suppressants typically must either displace the oxygen and/or fuel near a fire, or mix with the air near the fire until a concentration is reached at which the fire is no longer supported. If the suppressant either does not reach a particular point or does not build up to sufficient levels at that point, flames at that location may persist. Thus, it is often desirable to disperse the suppressant thoroughly, rapidly, and evenly throughout the entire area that a given nozzle or system is meant to protect.

Conventionally, such suppressants are distributed in a radial motion only. That is, the suppressant is expelled from a nozzle or similar structure and expands outward radially from that nozzle. In principle at least, this results in an expanding sphere of suppressant gas emanating from the nozzle.

However, this conventional arrangement is not entirely satisfactory.

For example, a radial distribution of suppressant may be susceptible to interference from objects in the protected area, such as production equipment, storage units, etc. Such objects may constitute obstacles to a radial flow of suppressant, interfering with thorough dispersion of the suppressant. For example, if a piece of equipment is disposed between a conventional radial nozzle and a flame, the radial path that the suppressant otherwise might follow to reach the fire may be blocked. In such instance, the suppressant may not reach and/or build up in the area of the fire as quickly as might be the case if the obstacle were not present. Similar effects may occur if the protected area is not uniform in shape.

Moreover, a conventional radial distribution typically takes the form of one or more discrete plumes of suppressant, extending outward from the nozzle. As a result, the spaces between plumes may have less suppressant than the areas of the plumes themselves. Thus, the initial distribution of suppressant may be less even than might be desired.

Conventionally, attempts to improve the distribution of suppressant have relied on increased suppressant pressure, increased suppressant volume, and/or an increased number of nozzles. However, this may result in the use of more suppressant, stronger distribution systems, and/or more nozzles than might otherwise be necessary for protected area of a given size.

### SUMMARY OF THE INVENTION

It is the purpose of the claimed invention to overcome these difficulties, thereby providing an improved apparatus and method for distributing a fluid, particularly a fire suppressant.

An exemplary embodiment of an atomizing nozzle in accordance with the principles of the present invention includes a nozzle body and a deflector body secured together in fixed relation. The nozzle body has an inlet port through the nozzle body that is adapted for connection with an outlet port, so that the nozzle may receive fluid therefrom.

The nozzle also has a flow passage defined between the deflector body and the nozzle body. The flow passage extends radially outwardly from the inlet port to a circumferential outlet slot, which is defined between the nozzle body and the deflector body and extends at least partially around the nozzle.

The flow passage defines an axis thereof.

The nozzle also includes vanes disposed in the flow passage. The vanes are arranged so as to impart a tangential velocity component relative to the axis to fluid flowing through the flow passage.

The vanes may be arranged such that the tangential velocity component is sufficient to impart to gas in the area a rotational motion about the axis.

The ratio of the magnitude of the tangential velocity component of the suppressant to the magnitude of the radial velocity component of the suppressant may be at least 1:10; that is, the tangential velocity component may be at least one tenth as large as the radial velocity component. Alternatively, the ratio may be at least 1:5. The ratio may be at least 1:3. The ratio may be at least 1:2.

The flow passage of the atomizing nozzle may extend 360° around the axis. Alternatively, the flow passage may extend less than 360° around the axis. In particular, the flow passage may extend 180° around the axis.

The vanes may be removable. The vanes may be formed as a single, integral unit.

An exemplary embodiment of a fire suppression system in accordance with the principles of the present invention includes a supply of a volatile liquefied-gas fire suppressant having a vapor pressure sufficient to form a gaseous mixture with air that does not support combustion, for extinguishing fires. The system also includes a pipe network connected to the supply, the pipe network including at least one outlet port.

At least one atomizing nozzle is in communication with the outlet port. The atomizing nozzle includes a nozzle body and a deflector body secured together in fixed relation, the nozzle body having an inlet port therethrough connected to the outlet port of the pipe network.

A flow passage is defined between the deflector body and the nozzle body, the flow passage extending radially outwardly from the inlet port to a circumferential outlet slot. The circumferential outlet slot is defined between the nozzle body and the deflector body and extends at least partially around the nozzle.

The flow passage defines an axis thereof.

Vanes are disposed in the flow passage, arranged so as to impart to the suppressant a tangential velocity component relative to the axis.

The vanes may be arranged such that the tangential velocity component is sufficient to impart to gas in the area a rotational motion about the axis.

The ratio of the tangential velocity component of the suppressant to the radial velocity component of the suppressant may be at least 1:10, that is, the tangential velocity component may be at least one tenth as large as the radial velocity component.

The flow passage of the atomizing nozzle may extend 360° around the axis. Alternatively, the flow passage may extend less than 360° around the axis. In particular, the flow passage may extend 180° around the axis.

An exemplary embodiment of a kit for retrofitting an atomizing nozzle in accordance with the principles of the present invention is suited for a nozzle having a nozzle body and a deflector body secured together in fixed relation, with the nozzle body having an inlet port therethrough adapted for connection with an outlet port, so as to receive fluid therefrom. The nozzle also suitably has a flow passage defined between the deflector body and the nozzle body, the flow passage extending radially outwardly from the inlet port to a circumferential outlet slot, the circumferential outlet slot being defined between the nozzle body and the deflector body and extending at least partially around the nozzle, with the flow passage defining an axis thereof.

The kit includes vanes adapted to be disposed in the flow passage in an arrangement so as to impart a tangential velocity component relative to the axis to fluid flowing through the flow passage.

The vanes may be adapted to be arranged such that the tangential velocity component is sufficient to impart to gas in the area a rotational motion about the axis.

The vanes may be adapted to be arranged such that the ratio of the magnitude of the tangential velocity component of the suppressant to the magnitude of the radial velocity component of the suppressant is at least 1:10.

The vanes may be formed as a single, integral unit.

The kit may include instructions for retrofitting the nozzle.

An exemplary embodiment of a kit for retrofitting fire suppression system in accordance with the principles of the present invention is suited for a system having a supply of a volatile liquefied-gas fire suppressant with a vapor pressure sufficient to form a gaseous mixture with air that does not support combustion, for extinguishing fires. A pipe network suitably is connected to the supply, the pipe network having at least one outlet port.

The kit includes at least one atomizing nozzle. The nozzle includes a nozzle body and a deflector body secured together in fixed relation, the nozzle body having an inlet port therethrough adapted for connection with the outlet port, so as to receive fluid therefrom. The nozzle also includes a flow passage defined between the deflector body and the nozzle body, the flow passage extending radially outwardly from the inlet port to a circumferential outlet slot, the circumferential outlet slot being defined between the nozzle body and the deflector body and extending at least partially around the nozzle. The flow passage defines an axis thereof.

The kit also includes vanes disposed in the flow passage, arranged so as to impart a tangential velocity component relative to the axis to fluid flowing through the flow passage.

The kit vanes may be arranged such that the tangential velocity component is sufficient to impart to gas in the area a rotational motion about the axis.

The vanes may be arranged such that the ratio of the magnitude of the tangential velocity component of the suppressant to the magnitude of the radial velocity component of the suppressant is at least 1:10.

The flow passage may extend 360° around the axis. Alternatively, the flow passage may extend less than 360° around the axis. In particular, the flow passage may extend 180° around the axis.

The kit may include instructions for retrofitting the system.

An exemplary method of suppressing a fire in accordance with the principles of the present invention includes communicating a volatile liquefied-gas fire suppressant to at least one nozzle, the nozzle defining an axis, atomizing the fire suppressant with the nozzle so as to vaporize the fire suppressant to a gaseous state, and imparting to the fire suppressant a tangential velocity component relative to the axis.

The tangential velocity component may be sufficient to impart to gas in the area a rotational motion about the axis.

The ratio of the magnitude of the tangential velocity component of the suppressant to the magnitude of the radial velocity component of the suppressant may be at least 1:10; that is, the tangential velocity component may be at least one tenth as large as the radial velocity component. Alternatively, the ratio may be at least 1:5. The ratio may be at least 1:3. The ratio may be at least 1:2.

The suppressant may exit the nozzle in an arc extending 360° around the axis. Alternatively, the suppressant may exit the nozzle in an arc less than 360° around the axis. In particular, the suppressant may exit the nozzle in an arc extending 180° around the axis.

The fire suppressant may be sprayed in a liquid state in a fan sufficiently thin such that the fire suppressant vaporizes without substantial liquid contact with the structure wherein the nozzle is disposed.

An exemplary method of suppressing a fire in an area in accordance with the principles of the present invention includes communicating a volatile liquefied-gas fire suppressant to at least one nozzle, the nozzle defining an axis, atomizing the fire suppressant with the nozzle so as to vaporize the fire suppressant to a gaseous state, and imparting to gas in the area a rotational motion about the axis.

The fire suppressant may be sprayed in a liquid state in a fan sufficiently thin such that the fire suppressant vaporizes without substantial liquid contact with the structure wherein the nozzle is disposed.

An exemplary method of retrofitting an atomizing nozzle in accordance with the principles of the present invention is suited for a nozzle having a nozzle body and a deflector body secured together in fixed relation, with the nozzle body having an inlet port therethrough adapted for connection with an outlet port, so as to receive fluid therefrom. The nozzle also suitably has a flow passage defined between the deflector body and the nozzle body, the flow passage extending radially outwardly from the inlet port to a circumferential outlet slot, the circumferential outlet slot being defined between the nozzle body and the deflector body and extending at least partially around the nozzle, with the flow passage defining an axis thereof.

The method includes disposing vanes in the flow passage, the vanes being arranged so as to impart a tangential velocity component relative to the axis to fluid flowing through the flow passage.

The tangential velocity component may be sufficient to impart to gas in the area a rotational motion about the axis.

The ratio of the magnitude of the tangential velocity component of the suppressant to the magnitude of the radial velocity component of the suppressant may be at least 1:10.

An exemplary method for retrofitting a fire suppression system in accordance with the principles of the present invention is suited for a system having a supply of a volatile liquefied-gas fire suppressant with a vapor pressure sufficient to form a gaseous mixture with air that does not support combustion for extinguishing fires, and a pipe network connected to the supply, the pipe network including at least one outlet port.

The method includes connecting at least one atomizing nozzle to the outlet port. The nozzle includes a nozzle body and a deflector body secured together in fixed relation, the nozzle body having an inlet port therethrough adapted for connection with the outlet port, so as to receive fluid therefrom. The nozzle also includes a flow passage defined between the deflector body and the nozzle body, the flow passage extending radially outwardly from the inlet port to a circumferential outlet slot, the circumferential outlet slot being defined between the nozzle body and the deflector body and extending at least partially around the nozzle, the flow passage defining an axis thereof. Vanes are disposed in the flow passage, the vanes being arranged so as to impart a tangential velocity component relative to the axis to fluid flowing through the flow passage.

The tangential velocity component may be sufficient to impart to gas in the area a rotational motion about the axis.

The ratio of the magnitude of the tangential velocity component of the suppressant to the magnitude of the radial velocity component of the suppressant may be at least 1:10.

### BRIEF DESCRIPTION OF THE DRAWINGS

Like reference numbers generally indicate corresponding elements in the figures.

FIG. 1 is a partly schematic illustration showing an exemplary embodiment of a fire suppression system in accordance with the principles of the present invention.

FIG. 2 shows the system of FIG. 1 with the fire suppression system in an active fire suppression mode.

FIG. 3 is an external top view showing an exemplary embodiment of a nozzle in accordance with the principles of the present invention.

FIG. 4 shows a cross section of an exemplary embodiment of a 360° nozzle in accordance with the principles of the present invention, similar to that in FIG. 3, taken along line A-A.

FIG. 5 shows a cross-section of the nozzle in FIG. 4, taken along line B-B.

FIG. 6 shows a cross section of another exemplary embodiment of a 360° nozzle in accordance with the principles of the present invention.

FIG. 7 shows a cross section of an exemplary embodiment of a 180° nozzle in accordance with the principles of the present invention.

FIG. 8 shows a cross section of another exemplary embodiment of a 360° nozzle in accordance with the principles of the present invention, similar to that in FIG. 3, taken along line A-A.

### DETAILED DESCRIPTION OF THE PREFERRED EMBODIMENT

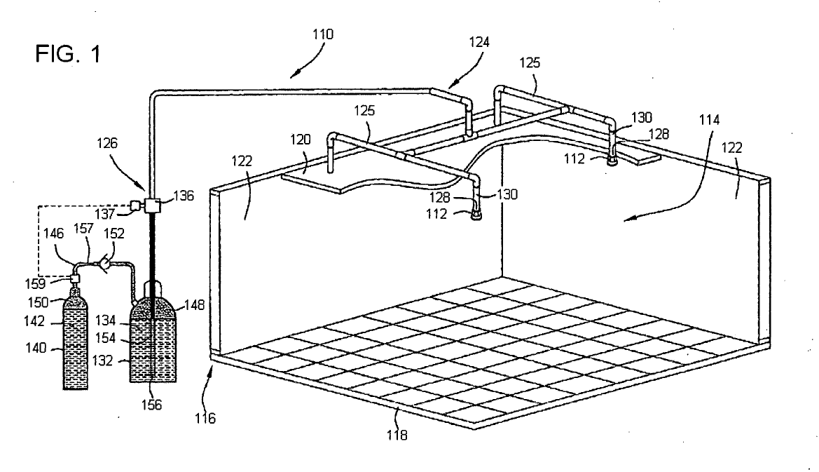

For purposes of illustration, an exemplary embodiment of a fire suppression system in accordance with the principles of the present invention is illustrated in FIG. 1. Therein, a fixed clean agent fire suppression system 110 is shown, incorporating a plurality of atomizing nozzles 112 for an area 114 of a building 116 or other similar structure (e.g. a large vessel, etc.). For purposes of orientation and reference, the building 116 includes a floor 118, a ceiling 120, and a plurality of walls 122 extending vertically between the floor and ceiling.

The system 110 generally includes a pipe network 124 of multiple interconnected pipes 125 for communicating volatile liquefied-gas fire suppressant toward the area 114. The pipe network 124 may be an existing network previously used, for example as part of a Halon 1301 system, such that the disclosed fire suppression system is a retrofit system. Alternatively, the pipe network 124 may be a new set of plumbing for a newly installed system. In either event, the pipe network 124 generally has an input end 126 for receiving clean agent and a plurality of outlet ports 128 for discharging clean agent into the area 114. In a typical system, the pipe network 124 generally extends throughout the ceiling 120 and/or the walls 122 of the building 116. In either event, the outlet ports 128 are typically provided by vertically downward extending branch pipes 130.

At the input end 126, the pipe network is connected to a tank or cylinder 132 of liquefied-gas fire suppressant 134 through a valve 136. The valve may be a two-way valve, or other suitable valve having open and closed states for selectively allowing or preventing flow. Depending on the particulars of a given embodiment, the valve 136 may be actuated by a user control 137 or an automatic control in response to a fire sensor, to allow the liquefied-gas fire suppressant 134 to flow through the pipe network 124.

The gas fire suppressant 134 is stored in a liquefied state in the cylinder 132. Typically, the liquefied-gas fire suppressant will be stored at a low pressure of between 0.4 psig and 100 psig at room temperature, 25° C. In the exemplary embodiment described herein, the gas fire suppressant 134 comprises at least one of the following liquefied-gases: 1,1,1,2,3,3,3-heptafluoropropane (HFC-227ea), and 1,1,1,3,3,3-hexafluoropropane (HFC-236fa). The more commonly used HFC-227ea has a boiling point of about −16.4° C. (2.5° F.) such that it normally assumes a gaseous state at room temperature, 25° C. Although two suppressing agents are disclosed, other agents may be equally suitable. For example, it will be appreciated that the system is generally applicable to fire suppressants comprising at least one liquefied-gas selected from the following classes: hydrofluourocarbons, perfluorocarbons, and hydroclorofluorocarbons, chemical variations of these which may include other atoms within the molecular structure such as oxygen, or other suitable liquefied-gases that act as fire suppressants (including but not limited to certain forms of halogenated ketones, aldehydes, alcohols, ethers, and esters).

It is an aspect of the present invention that a piston flow system may be used to push the gas fire suppressant 134 through the pipe network 124. In particular, a tank or cylinder 140 of a gas propellant 142 may be arranged in fluid series with the clean agent cylinder 132. The propellant 142 may be a non-condensable gas, such as nitrogen or argon, or a liquefied compressed gas, such as carbon dioxide, which has a much lower boiling point than the fire suppressant 134 such that it provides a large pressure and propelling force for pushing the fire suppressant 134 through the pipe network 124. The gas propellant 142 is selected for fire safety and also to provide suitable propelling force by having a low boiling point. Suitable propellants for the system 110 include, but are not limited to, any of the following gases: carbon dioxide, nitrogen, and argon.

The compressed gas or liquefied compressed gas propellant 142 is stored separately from the liquefied fire suppressant 134. A connecting hose 146 connects the vapor area or gas zones 148, 150 above the liquid in the cylinders 132, 140. Preferably, mixing of the vapor area gas zones 148, 150 is prevented with an on/off propellant valve 159 between the cylinders 140, 132 separating the propellant and clean agent. The propellant valve 159 may be the outlet valve of the propellant cylinder 140. In the alternative, some of the gas propellant 142 may also be allowed to enter the agent gas zone 148 in the clean agent cylinder 132 to maintain a high pressure load on the gas fire suppressant 134 in the compressed liquid state. A check valve 152 (which may also be a pressure relief valve) may also be arranged between the cylinders 132, 140. The check valve 152 is used to allow propellant 142 to enter the clean agent cylinder 132 while in an open state while preventing reverse flow while in the closed state. The piston flow system is also arranged such that when the propellant valve 159 is open, only propellant in the gaseous state enters the clean agent cylinder 132. By only allowing gaseous propellant 142 to enter the cylinder 132, there is very little mixing or dissolving of propellant into the contained liquid of fire suppressant.

Upon the occurrence of a fire in the area 114, the on/off propellant valve 159 and the on/off system valve 136 are opened by the manual control 137 or an automated control in response to a sensor. These two valves 136, 159 may be linked such that the opening of one causes the other to open as well. According to one implementation, the propellant valve 159 is actuated to an open position releasing high pressure propellant. The on/off system valve 136 is connected to pressure downstream of the propellant valve 159 and actuated by this pressure.

Once the valves 136, 159 are opened, the propellant 142 pushes the fire suppressant 134 in a liquid state out of the agent cylinder 132 through a siphon tube 154 that has a fluid inlet 156 proximate the bottom of the cylinder 132. It will be appreciated to those skilled in the art that an alternative to the siphon tube 154 is to place the outlet port of the agent cylinder at or near the vertical bottom of the cylinder, again for the purposes of drawing the fire suppressant in liquid form. In either event, the fire suppressant 134 is delivered and pushed out of the agent cylinder 132 in a compressed liquid state into the pipe network 124. As the liquid volume in the agent cylinder 132 drops, more high pressure propellant 142 is drawn off of the liquid supply of the propellant cylinder 140 and enters the agent cylinder 132 in gaseous form through the check valve 152 and connecting hose 146. The propellant 142 maintains pressure on the fire suppressant 134 to push it out through the siphon tube 154 in the compressed liquid state until the agent cylinder 132 is empty. The rate of transfer of the propellant to the agent container is limited by a selectively sized flow restriction 157 located at the inlet of the check valve 152. The restriction 157 is selectively sized to provide a predetermined pressure to the clean agent and a predetermined flow rate of clean agent through the pipe network. The size of the restriction 157 is a variable that is selected and can be changed from system to system to meet the particular system requirements.

By preventing the propellant 142 from dissolving in the liquefied-gas fire suppressant 134, the fire suppressant 134 advantageously maintains a one phase liquid state when being pushed through the pipe network 124. The propellant 142 maintains a high enough pressure on the fire suppressant 134 to maintain the one phase liquid state despite a small pressure drop upon entering the pipe network 124. Virtually no propellant 142 dissolves into the liquefied-gas fire suppressant 134 being delivered through the pipe network 124. As such, vaporization of propellant 142 in the pipe network 124 is not a problem. This maintains a high mass flow rate of compressed liquefied-gas fire suppressant 134 through the pipe network because the volume of the pipe network 124 is occupied by a one phase high-density liquid instead of a two phase low-density liquid and gas combination.

While the disclosed embodiment achieves a high mass flow rate, there is no dissolved propellant in the liquefied-gas fire suppressant 134 to break the discharged fire suppressant 134 into small droplets for more rapid vaporization. The disclosed embodiment resolves this issue through another aspect of the invention, namely, a plurality of atomizing nozzles 112 mounted to the outlet ports 128 of the pipe network 124.

However, it is emphasized that this arrangement, that is, a piston flow system wherein a separate tank or cylinder 140 of gas propellant 142 is used to drive the suppressant 134 from a clean agent cylinder is exemplary only. The present invention is not particularly limited with regard to the manner by which fire suppressant 134 is delivered to the atomizing nozzles 112.

For example, for some embodiments a superpressurized agent cylinder may be suitable. That is, the propellant and fire suppressant 134 may be disposed within a single cylinder or tank.

Other arrangements may be equally suitable.

As shown in FIG. 1, the atomizing nozzles 112 are arranged in spaced relation throughout the area 114. The atomizing nozzles 112 work by spraying the discharged fire suppressant 134 still in liquid form outward into a thin liquid fan 160. Spraying the liquid out in a thin fan 160 produces a large surface area for the liquid, due to its thinning out as it is sprayed outward. The liquid rapidly vaporizes due to the large surface area, and the thin liquid fan 160 thins out to small droplets as it spreads outward.

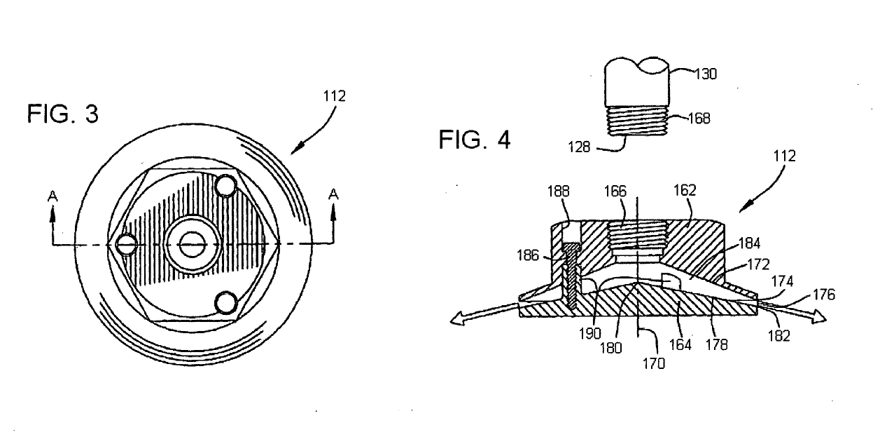

Referring to FIGS. 3 and 4, each atomizing nozzle 112 has a nozzle body 162 and a deflector body 164.

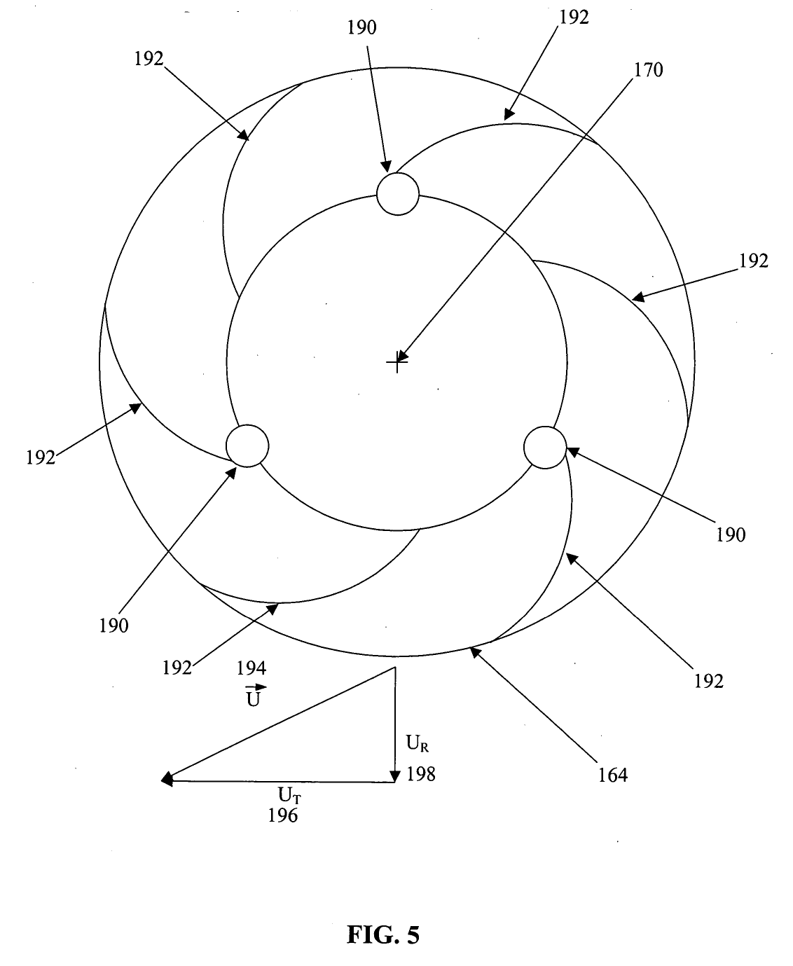

Referring to FIG. 5, the nozzle body 162 includes a threaded inlet port 166 that mounts onto the threaded end 168 of the branch outlet pipes 130. The threads of the inlet port 166 may be configured to correspond to the threaded inlet ports of the removed single round orifice jet nozzles (not shown) used on prior Halon 1301 systems so that the nozzles 112 can replace the Halon nozzles to provide for a retrofit system. The inlet port 166 extends along the nozzle axis 170 (also referred to as the vertical axis) until it intersects a flow surface 172 of the nozzle body 162.

The flow surface 172 extends radially outward from the nozzle axis 170 to form a top annular edge 174 of a circumferential outlet slot 176. The deflector body 164 includes a deflector surface 178 in spaced relation to the flow surface 172 of the nozzle body 162. The deflector surface 178 extends radially outward from a center point 180 defined by the intersection of the axis 170 and the deflector surface 178 to a bottom annular edge 182 to define the circumferential outlet slot 176 in combination with the top annular edge 174.

Thus, the nozzle body and deflector body surfaces 172, 178 define a flow passage 184 therebetween that extends radially outwardly to the circumferential outlet slot 176. The flow passage 184 converges radially outwardly toward the circumferential outlet slot 176 that extends at least part of the way around the axis 170. The nozzle body 162 and deflector body 164 may be secured together with screws 186 or any other fastener or other suitable securing device. In the embodiment illustrated, the screws 186 extend through counter-bore holes 188 in the nozzle body 162 and are fastened into axially projecting threaded bosses 190 that project into the holes 188. The bosses 190 and holes 188 are arranged at spaced angular positions about the axis 170 but preferably radially inward of the outlet slot 176.

The nozzles 112 atomize the fire suppressant by spraying the fire suppressant 134 out of the circumferential outlet slot 176 forming the thin liquid fan 160. Fire suppressant 134 enters the inlet port 166 axially is redirected radially outward through flow passage 184 where it is discharged and sprayed radially outward in the shape of a thin liquid fan 160 for vaporization.

In addition, with reference to FIG. 5, vanes 192 are disposed within the flow passage 184. (The vanes are not illustrated in FIG. 4, for clarity.) The vanes are arranged so as to impart a tangential velocity component relative to the axis 170 to fire suppressant 134 passing through the flow passage 184.

FIG. 5 includes a vector diagram illustrating an exemplary arrangement of the sort described above.

Fire suppressant 134 passing through flow passage 184 exits with a velocity vector 194 of \vec{U}. This velocity vector 194 may be separated into two components, a radial velocity component 196 that is radial with respect to the axis 170, and a tangential velocity component 198 that is tangential to the axis 170. As illustrated, the radial component 196 is U_{R}, and the tangential component 196 is U_{T}.

In other words, as the fire suppressant 134 exits the flow passage 184, and thus exits the nozzle 112, it has not only linear motion radially outward from the axis 170, but also angular or rotational motion about the axis 170.

In turn, when the fire suppressant 134 begins to interact with the air (or other fluid) in the volume surrounding the nozzle 112, it produces a rotational motion of both the fire suppressant 134 and the air. Thus, not only the fire suppressant 134 itself but at least a portion of the air in the protected volume undergoes a rotary or swirling motion. Typically this rotational motion is at least substantially centered on the axis 170.

The distribution of fire suppressant 134 within the protected volume may be considered somewhat analogous to an arrangement wherein one liquid is added to another and then stirred. However, instead of simply being “poured” into the air, or otherwise added in a purely linear fashion, with a nozzle 112 in accordance with the principles of the present invention the fire suppressant 134 is added with a tangential velocity component 198 such that both the fire suppressant 134 and the surrounding air are “stirred”.

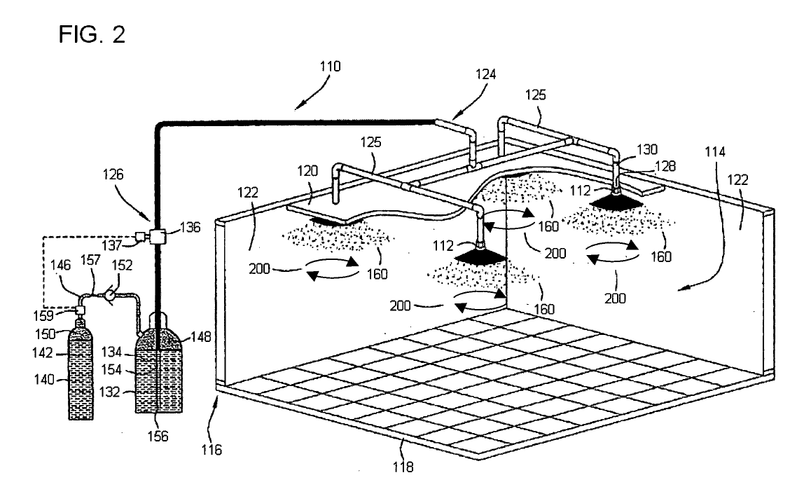

Such an arrangement is illustrated in FIG. 2. Therein, the air/suppressant mixture produced near the nozzles 112 is shown to have a rotational motion 200. Although for purposes of simplicity only a few arrows indicative of the rotational motion 200 are shown, and they are illustrated relatively close to the nozzles 112, the actual volume of air/suppressant that is made to move in a rotational manner may be substantial.

In addition, although in FIG. 2 all of the nozzles 112 produce rotational motion 200 in the same direction, this is exemplary only. In a system having multiple nozzles 112, it is not necessary for all nozzles 112 to produce the same direction of rotational motion 200.

Although the rotational motion is referred to in places herein as a “stirring” action, it is emphasized that the rotational motion does not have to be added by an external “stirring” source. Rather, it is the tangential velocity component 198 of the fire suppressant 134 itself that induces the rotational motion of fire suppressant 134 and air.

Such an arrangement may yield a number of advantages over conventional arrangements for purely radial distribution.

As may be understood for example with respect to the analogy of stirred liquids, a fluid fire suppressant 134 may mix more rapidly with the surrounding air or other ambient fluid in the protected area if the fire suppressant 134 and air are “stirred” together by imparting a tangential velocity to the fire suppressant 134.

Similarly, imparting a tangential velocity component 198 to the fire suppressant 134 may yield a more uniform distribution of fire suppressant 134 within the protected volume. For example, even if a specific nozzle arrangement initially produces plumes of fire suppressant 134, or an otherwise uneven initial distribution, the rotational motion of the fire suppressant 134 and air typically tends to facilitate uniform mixing of those fluids.

In addition, providing a tangential velocity component 198 to the fire suppressant 134 may result in more efficient use of fire suppressant 134. For example, as noted above, distribution of fire suppressant 134 may be more rapid and/or more uniform with the rotary motion provided by a nozzle 112 in accordance with the principles of the present invention than with a purely radial dispersion of fire suppressant 134.

Functionally, in order to begin to suppress a fire within a given time, it may be desirable to produce within that time a minimum concentration of fire suppressant 134 throughout the volume that is to be protected.

However, if the speed of distribution is low, portions of the volume to be protected may be “starved”, that is, they may not receive sufficient fire suppressant 134 to reach the minimum concentration in the time allowed. It may be possible to compensate for this by discharging more fire suppressant 134 than is absolutely required to reach the minimum concentration that is desired throughout the protected volume. However, such an arrangement typically may be inefficient, since greater amounts of fire suppressant 134 are used to offset a low distribution speed. Also, additional nozzles, conduits, etc. may be necessary to facilitate the distribution of the additional fire suppressant 134.

Essentially, then such an arrangement sacrifices efficiency for speed. However, as the speed of distribution increases, i.e. by imparting a tangential velocity component 198 to the fire suppressant 134, the need to trade efficiency for speed of distribution may be reduced or eliminated.

Likewise, a similar trade-off may be made if the uniformity of fire suppressant 134 distribution is low. Additional fire suppressant 134 may be distributed, resulting in unnecessarily high levels of fire suppressant 134 in certain portions of the protected volume, in order to reach a minimum concentration of fire suppressant 134 in other portions of the protected volume. As with the speed trade-off described above, as the uniformity of distribution increases, i.e. by imparting a tangential velocity component 198 to the fire suppressant 134, the need to trade efficiency for uniformity of distribution may be reduced or eliminated.

Furthermore, giving a tangential velocity component 198 to the fire suppressant 134 may result in more effective distribution of fire suppressant 134. As noted, rotary motion of the air and fire suppressant 134 may improve the mixing of those fluids. As a result, portions of the protected volume which may be difficult to reach with a simple radial distribution of fire suppressant 134—for example, regions behind equipment or other obstacles—may more readily be reached by fire suppressant 134 when a rotary motion as present, as with the present invention.

The specific dynamics of a given mixture of fire suppressant 134 and ambient fluid—i.e. the precise magnitudes of improvements in speed of distribution, etc.—will depend on a variety of factors, including but not limited to the specific properties of the individual fire suppressant 134 and ambient fluid; however, as may be seen from experience with liquids, rotational motion typically provides for increased speed of mixing, greater uniformity of mixing, etc.

The precise structure and arrangement of the vanes 192 may vary from embodiment to embodiment. In the arrangement illustrated in FIG. 5, six straight vanes 192 are shown, distributed evenly about the full circumference of the nozzles 112. However, this is exemplary only, in several regards.

First, the number of vanes 192 may vary. Likewise, the relative distribution of the vanes 192 may vary; for example, it is not necessary for the vanes to be evenly spaced.

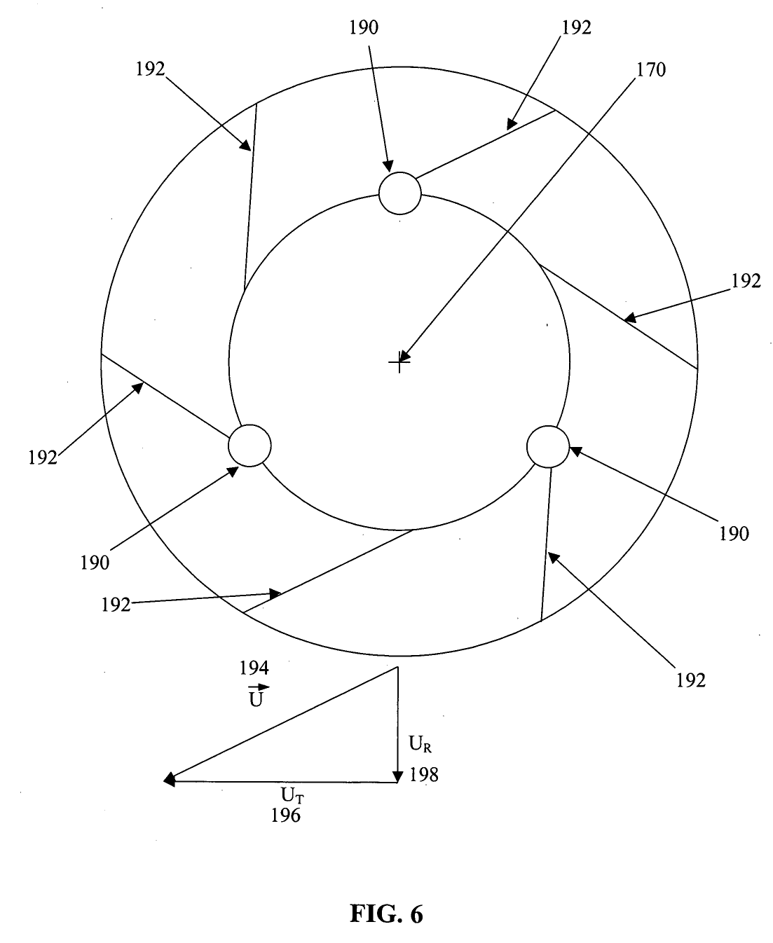

In addition, the shape of the vanes may vary from embodiment to embodiment. FIG. 6, for example, shows another exemplary arrangement, wherein the vanes 192 are curved. Other arrangements also may be equally suitable.

Typically, the vanes 192 within a given nozzle 112 will have at least approximately the same shape, and will be spaced at least approximately evenly around the axis 170. This may be seen in FIGS. 5 and 6, wherein all of the vanes 192 are similarly straight and similarly curved, respectively, and wherein the vanes 192 are spaced evenly. The vanes 192 thus define therebetween a plurality of similar sections within the flow passage 184.

However, an arrangement of identical vanes 192 that are spaced at identical intervals around the axis 170 is exemplary only. In particular, minor variations in the shape of the sections of the flow passage 184 defined by the vanes 192, may be suitable. For example, FIGS. 5 and 6, the bosses 190 project slightly into each section of the flow passage 184, and thus the sections are not identical. However, in the exemplary embodiments illustrated therein, the sections are similar in shape, and in particular the width of each section at its outer edge is essentially identical.

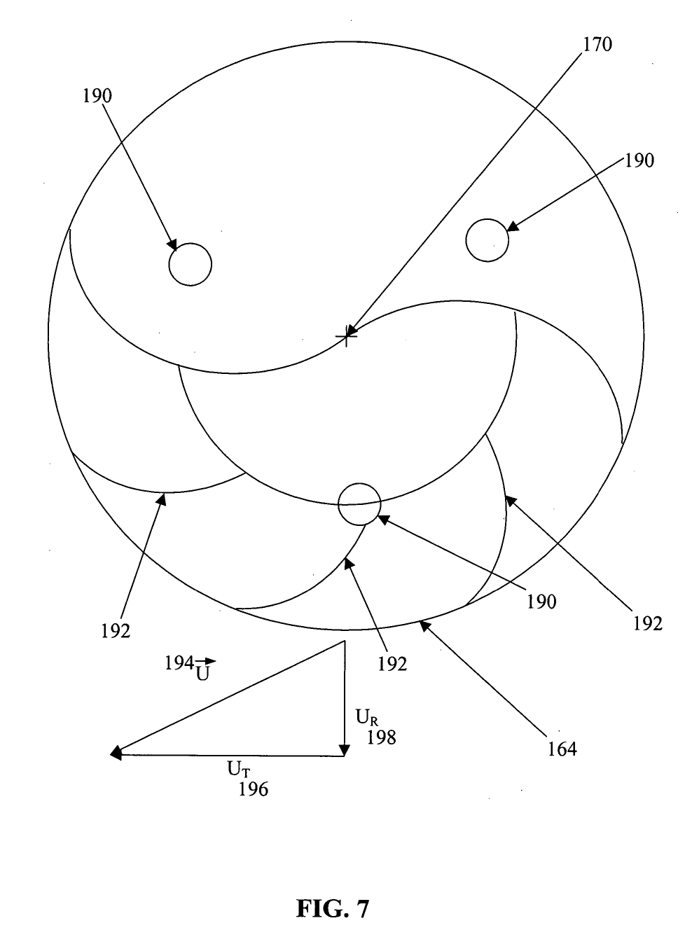

Although FIGS. 5 and 6 show arrangements wherein the flow passage 184 extends a full 360° around the axis 170, this is exemplary only. It is not necessary for the vanes 192, or the flow passage 184 to extend a full 360° around the axis 170 of the nozzles 112, or for the vanes 192 to be distributed about the entire circumference of the nozzle 112. For example, FIG. 7 shows a cross section of an exemplary nozzle 112 wherein the vanes 192 and the flow passage 184 extend less than 360° around the axis 170, specifically 180°.

As with the 360° arrangements shown in FIGS. 5 and 6, the exemplary arrangement in FIG. 7 also has vanes 192 that are approximately the same shape, and are spaced approximately evenly around the axis 170. Thus, although the flow passage 184 of a 180° nozzle 112 as in FIG. 7 is different in overall shape from a that of a 360° nozzle 112 as shown in FIGS. 5 and 6, the several sections of the flow passage 184 in the 180° nozzle 112 of FIG. 7 nevertheless may be similar to one another. In particular, as may be seen in FIG. 7, the width of each section at its outer edge may be essentially identical.

A 360° nozzle 112 such as that shown in FIG. 5 sprays a thin liquid fan 160 all or substantially all of the way around the nozzle, the 360° fan 160 then quickly dispersing into the gas fire suppressant 134. By contrast, a 180° nozzle 112 as shown in FIG. 7 sprays a thin liquid fan 160 about one half of the way around the nozzle. Such an arrangement may be advantageous, for example, for preventing liquid interference between the thin liquid fan 160 with the walls 122, while nevertheless quickly dispersing the fire suppressant 134.

Other arrangements, in addition to 360° and 180° nozzles 112, may be equally suitable. In addition, for systems having more than one nozzle 112, it may be suitable to combine nozzles having flow passages 184 of differing angular extent (thus producing distributions of fire suppressant 134 having differing angular extent) in the same system.

In addition, the nozzle 112 may spray in a trajectory that is angled vertically upward or downward from the axis 170. For example, a downward angle of between about 45° and about 90° relative to the vertical nozzle axis 170 may be suitable, though other angles may be equally suitable.

For example, FIG. 4 shows an embodiment wherein the flow passage 184 is defined so as to be conical in shape. As shown, it has a slight downward angle, in the range of 10° to 15° from horizontal, or about 75° to 80° with respect to the vertical nozzle axis 170.

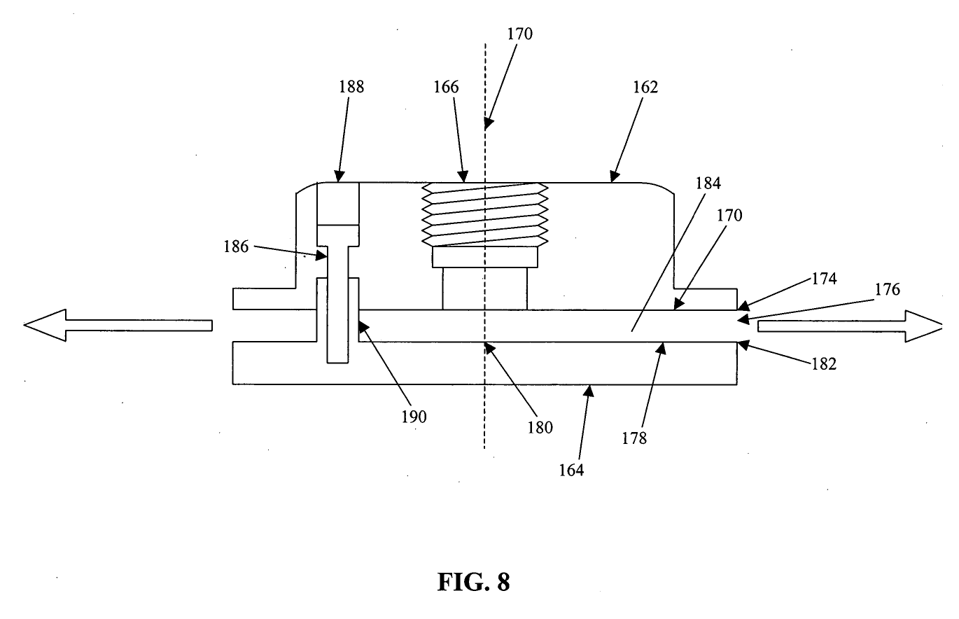

However, such an arrangement is exemplary only. Angles other than those between about 45° and about 90° relative to the vertical nozzle axis 170 may be suitable. In particular, an angle of 90° relative to the vertical nozzle axis 170, that is, at 0° with respect to the horizontal, may be equally suitable. Such an arrangement is illustrated in FIG. 8.

In an arrangement such as that illustrated in FIG. 8, the fire suppressant 134 would be distributed in a thin liquid fan 160 that is, at least initially upon leaving the nozzle 112, essentially horizontal.

Returning to the arrangement of the vanes 192, the vanes 192 also may be oriented to produce a variety of vector ratios. For example, the ratio of the magnitude of the tangential velocity component U_{T} of the suppressant 134 to the magnitude of the radial velocity component U_{R} of the suppressant 134 may be at least 1:10.

However, the ratio of the magnitude of the tangential velocity component U_{T} of the suppressant 134 to the magnitude of the radial velocity component U_{R} of the suppressant 134 is not particularly limited, so long as the circular motion described herein is produced thereby. For example, the ratio of the magnitude of the tangential velocity component U_{T} of the suppressant 134 to the magnitude of the radial velocity component U_{R} of the suppressant 134 may be at least 1:5.

The ratio of the magnitude of the tangential velocity component U_{T} of the suppressant 134 to the magnitude of the radial velocity component U_{R} of the suppressant 134 may be at least 1:3.

The ratio of the magnitude of the tangential velocity component U_{T} of the suppressant 134 to the magnitude of the radial velocity component U_{R} of the suppressant 134 may be at least 1:2.

The ratio of the magnitude of the tangential velocity component U_{T} of the suppressant 134 to the magnitude of the radial velocity component U_{R} of the suppressant 134 may be at least 1:1.

The ratio of the magnitude of the tangential velocity component U_{T} of the suppressant 134 to the magnitude of the radial velocity component U_{R} of the suppressant 134 may be at least 2:1.

The ratio of the magnitude of the tangential velocity component U_{T} of the suppressant 134 to the magnitude of the radial velocity component U_{R} of the suppressant 134 may be at least 3:1.

By varying this ratio, properties such as the speed of rotational motion of fire suppressant 134 and air, the total volume of space wherein the air is made to rotate, etc. likewise may be varied.

For certain embodiments, the vanes 192 may be adjustable, such that the ratio of the magnitude of the tangential velocity component U_{T} of the suppressant 134 to the magnitude of the radial velocity component U_{R} of the suppressant 134 may be varied. In addition, for certain embodiments the vanes 192 may be adjustable remotely, and/or automatically. Alternatively, certain embodiments of the nozzle 112 may be adapted to receive any of several configurations of vanes 192, so as to produce different such ratios.

For certain embodiments of the nozzle 112, the vanes 192 may be removable, and/or replaceable.

The vanes 192 may be separate, individual components, or they may be part of an integral one-piece unit. For example, such an integral unit may facilitate replacement and/or retrofitting of vanes 192 in a given nozzle 112.

The nozzles 112 themselves likewise may be retrofitted to an existing fire suppression system.

Vanes 192 and/or nozzles 112 may be provided in kit form, for retrofitting to existing nozzles and/or fires suppression systems respectively.

The above specification, examples and data provide a complete description of the manufacture and use of the composition of the invention. Since many embodiments of the invention can be made without departing from the spirit and scope of the invention, the invention resides in the claims hereinafter appended.

1. An atomizing nozzle, comprising:
a nozzle body and a deflector body secured together in fixed relation, said nozzle body comprising an inlet port therethrough adapted for connection with an outlet port, so as to receive fluid therefrom;
a flow passage defined between said deflector body and said nozzle body, said flow passage extending radially outwardly from said inlet port to a circumferential outlet slot, said circumferential outlet slot being defined between said nozzle body and said deflector body and extending at least partially around said nozzle, said flow passage defining an axis thereof; and
a plurality of vanes disposed in said flow passage, said vanes being arranged so as to impart a tangential velocity component relative to said axis to fluid flowing through said flow passage;
wherein:
said nozzle is disposed such that suppressant passing therethrough enters an area; and
said vanes are arranged such that said tangential velocity component is sufficient to impart to gas in said area a rotational motion about said axis.

2. The atomizing nozzle of claim 1, wherein:
a ratio of a magnitude of said tangential velocity component of said suppressant to a magnitude of a radial velocity component of said suppressant is at least 1:10.

3. The atomizing nozzle of claim 1, wherein:
said flow passage extends 360° around said axis.

4. The atomizing nozzle of claim 1, wherein:
said flow passage extends less than 360° around said axis.

5. The atomizing nozzle of claim 4, wherein:
said flow passage extends 180° around said axis.

6. A fire suppression system, comprising:
a supply of a volatile liquefied-gas fire suppressant having a vapor pressure sufficient to form a gaseous mixture with air that does not support combustion for extinguishing fires;
a pipe network connected to said supply, said pipe network comprising at least one outlet port;
at least one atomizing nozzle according to claim 1 in communication with said outlet port

7. A kit for retrofitting an atomizing nozzle, said nozzle comprising:
a nozzle body and a deflector body secured together in fixed relation, said nozzle body comprising an inlet port therethrough adapted for connection with an outlet port, so as to receive fluid therefrom; and
a flow passage defined between said deflector body and said nozzle body, said flow passage extending radially outwardly from said inlet port to a circumferential outlet slot, said circumferential outlet slot being defined between said nozzle body and said deflector body and extending at least partially around said nozzle, said flow passage defining an axis thereof;
said kit comprising:
a plurality of vanes adapted to be disposed in said flow passage in an arrangement so as to impart a tangential velocity component relative to said axis to fluid flowing through said flow passage;
wherein
said nozzle is disposed such that suppressant passing therethrough enters an area;
said vanes are adapted to be arranged such that said tangential velocity component is sufficient to impart to gas in said area a rotational motion about said axis.

8 The kit of claim 7, wherein:
said vanes are adapted to be arranged such that a ratio of a magnitude of said tangential velocity component of said suppressant to a magnitude of a radial velocity component of said suppressant is at least 1:10.

9. The kit of claim 7, wherein:
said vanes comprise a single integral unit.

10. The kit of claim 7, further comprising:
instructions for retrofitting said nozzle.

11. A kit for retrofitting a fire suppression system, said system comprising:
a supply of a volatile liquefied-gas fire suppressant having a vapor pressure sufficient to form a gaseous mixture with air that does not support combustion for extinguishing fires; and
a pipe network connected to said supply, said pipe network comprising at least one outlet port;
said kit comprising:
at least one atomizing nozzle according to claim 1.

12. The kit of claim 11, further comprising:
instructions for retrofitting said system.

13. A method of suppressing a fire, comprising:
communicating a volatile liquefied-gas fire suppressant to at least one nozzle, said nozzle defining an axis;
atomizing said fire suppressant with said nozzle so as to vaporize said fire suppressant to a gaseous state; and
imparting to said fire suppressant a tangential velocity component relative to said axis;
wherein:
said nozzle is disposed such that suppressant passing therethrough enters an area; and
said tangential velocity component is sufficient to impart to gas in said area a rotational motion about said axis.

14. The method of claim 13, wherein:
a ratio of a magnitude of said tangential velocity component of said suppressant to a magnitude of a radial velocity component of said suppressant is at least 1:10.

15. The method of claim 13, wherein:
said suppressant exits said nozzle in an arc extending 360° around said axis.

16. The method of claim 13, wherein:
said suppressant exits said nozzle in an arc extending less than 360° around said axis.

17. The method of claim 16, wherein:
said suppressant exits said nozzle in an arc extending 180° around said axis.

18. A method of suppressing a fire in an area, comprising:
communicating a volatile liquefied-gas fire suppressant to at least one nozzle, said nozzle defining an axis;
atomizing said fire suppressant with said nozzle so as to vaporize said fire suppressant to a gaseous state; and
imparting to gas in said area a rotational motion about said axis.

19. A method of retrofitting an atomizing nozzle, said nozzle comprising:
a nozzle body and a deflector body secured together in fixed relation, said nozzle body comprising an inlet port therethrough adapted for connection with an outlet port, so as to receive fluid therefrom; and
a flow passage defined between said deflector body and said nozzle body, said flow passage extending radially outwardly from said inlet port to a circumferential outlet slot, said circumferential outlet slot being defined between said nozzle body and said deflector body and extending at least partially around said nozzle, said flow passage defining an axis thereof;
said method comprising:
disposing a plurality of vanes in said flow passage, said vanes being arranged so as to impart a tangential velocity component relative to said axis to fluid flowing through said flow passage;
wherein:
said nozzle is disposed such that suppressant passing therethrough enters an area; and
said tangential velocity component is sufficient to impart to gas in said area a rotational motion about said axis.

20. The method of claim 19, wherein:
a ratio of a magnitude of said tangential velocity component of said suppressant to a magnitude of a radial velocity component of said suppressant is at least 1:10.

21. A method for retrofitting a fire suppression system, said system comprising:
a supply of a volatile liquefied-gas fire suppressant having a vapor pressure sufficient to form a gaseous mixture with air that does not support combustion for extinguishing fires; and
a pipe network connected to said supply, said pipe network comprising at least one outlet port;
said method comprising:
connecting at least one atomizing nozzle to said at least one outlet port, said nozzle comprising:
a nozzle body and a deflector body secured together in fixed relation, said nozzle body comprising an inlet port therethrough adapted for connection with said outlet port, so as to receive fluid therefrom;
a flow passage defined between said deflector body and said nozzle body, said flow passage extending radially outwardly from said inlet port to a circumferential outlet slot, said circumferential outlet slot being defined between said nozzle body and said deflector body and extending at least partially around said nozzle, said flow passage defining an axis thereof; and
a plurality of vanes disposed in said flow passage, said vanes being arranged so as to impart a tangential velocity component relative to said axis to fluid flowing through said flow passage;
wherein:
said nozzle is disposed such that suppressant passing therethrough enters an area; and
said tangential velocity component is sufficient to impart to gas in said area a rotational motion about said axis.

22. The method of claim 21, wherein:
a ratio of a magnitude of said tangential velocity component of said suppressant to a magnitude of a radial velocity component of said suppressant is at least 1:10.
